(19) United States
(12) Patent Application Publication
(10) Pub. No.: US 2009/0090189 A1
(43) Pub. Date: Apr. 9, 2009

(54) CYLINDER PRESSURE SENSOR SYSTEM

(76) Inventor: William L. Villaire, Clarkston, MI (US)

Correspondence Address: DELPHI TECHNOLOGIES, INC., M/C 480-410-202, PO BOX 5052, TROY, MI, 48007, US

(21) Appl. No.: 11/867,261

(22) Filed: Oct. 4, 2007

(51) Int. Cl. G01L 9/00

(52) U.S. Cl. 73/723

(57) ABSTRACT

An engine intake valve has a threaded blind bore opening from its top surface facing the engine cylinder. A pressure sensor has a body portion whose exterior is threaded and is configured in size and shape to be completely received within and retained in the blind bore. The pressure sensor is configured to generate a pressure signal indicative of the cylinder pressure.

### TECHNICAL FIELD

This invention relates generally to sensor systems, and more particularly, to a cylinder pressure sensor system for sensing a pressure in a cylinder of an internal combustion engine.

### BACKGROUND OF THE INVENTION

In the automotive industry, among others, it is known to employ ever-increasingly sophisticated engine management techniques for the control of an internal combustion engine. This is due to the desire to improve fuel economy as well as reduce emissions and/or comply with emissions standards. In this regard, one type of control sensor desirable for use is a pressure sensor to detect the pressure in the combustion chamber (i.e., cylinder), which information may be used as feedback for adjusting fuel delivery and spark timing parameters, among other uses. Other known uses for combustion pressure information include exhaust gas recirculation (EGR) control and combustion knock detection.

One approach known in the art for implementing cylinder pressure sensing is to combine the pressure sensor with a spark ignition device, as seen by reference to U.S. Pat. No. 6,948,372 entitled “METHOD OF CONNECTION TO A SPARK PLUG PRESSURE SENSOR” issued to Skinner et al, owned by the common assignee of the present invention and hereby incorporated by reference herein in its entirety. Skinner et al. disclose a pressure sensor associated with a spark plug that is itself connected to an ignition coil.

Another approach known in the art is to provide a separate port in the engine itself for installation of a cylinder pressure sensor. However, this approach is considered undesirable by engine manufacturers.

There is therefore a need to provide a cylinder pressure sensor system that minimizes or eliminates one or more of the problems set forth above.

### SUMMARY OF THE INVENTION

The present invention is directed to an improved approach for packaging a cylinder pressure sensor. The invention has the advantage of eliminating the need to provide a separate port in the engine whose sole purpose would be to install a cylinder pressure sensor.

A cylinder pressure sensor system according to the invention includes an engine valve, already present in an internal combustion engine, and a pressure sensor. The valve may comprise an otherwise conventional engine valve (e.g., an intake valve) having head, neck and stem portions. The pressure sensor is disposed in the head of the valve, facing or otherwise exposed to the combustion chamber and configured to generate a pressure signal indicative of a pressure in the combustion chamber.

In one embodiment, the valve includes a threaded, blind bore having an opening on the cap (top) side of the valve head. The bore may extend into the neck portion, depending on the size of the sensor relative to the valve. The bore also includes an inwardly tapered sealing section (chamfer). The pressure sensor is configured in size and shape to fit into the blind bore, and includes a seal surface and threads configured to mesh with the threads of the bore to retain the pressure sensor in the bore. The sealing section of the bore and the seal surface of the sensor cooperate to form a pressure-tight seal. The valve further includes, in one embodiment, a guideway configured to allow electrical leads from the sensor to pass out of the bore, destined for connection to an electronic engine controller or the like.

Other features, aspects and advantages of the present are also presented.

### BRIEF DESCRIPTION OF THE DRAWINGS

The present invention will now be described by way of example, with reference to the accompanying drawings:

FIG. 1 is a cross-sectional view of an assembled cylinder pressure sensor system of the present invention comprising an engine valve and a pressure sensor.

FIG. 2 is an enlarged, cross-sectional view of a blind bore portion of the valve shown in FIG. 1 suitable for completely receiving and retaining the pressure sensor.

FIG. 3 is a top view of the cylinder pressure sensor system of FIG. 1, showing a pressure sensor portion installation and removal feature.

FIG. 4 is a top view of an alternate embodiment of the pressure sensor portion having a hex head for installation and removal purposes.

FIG. 5 is simplified, cross-sectional view of an engine system adapted to use the cylinder pressure sensor system of FIG. 1.

### DETAILED DESCRIPTION OF THE PREFERRED EMBODIMENT

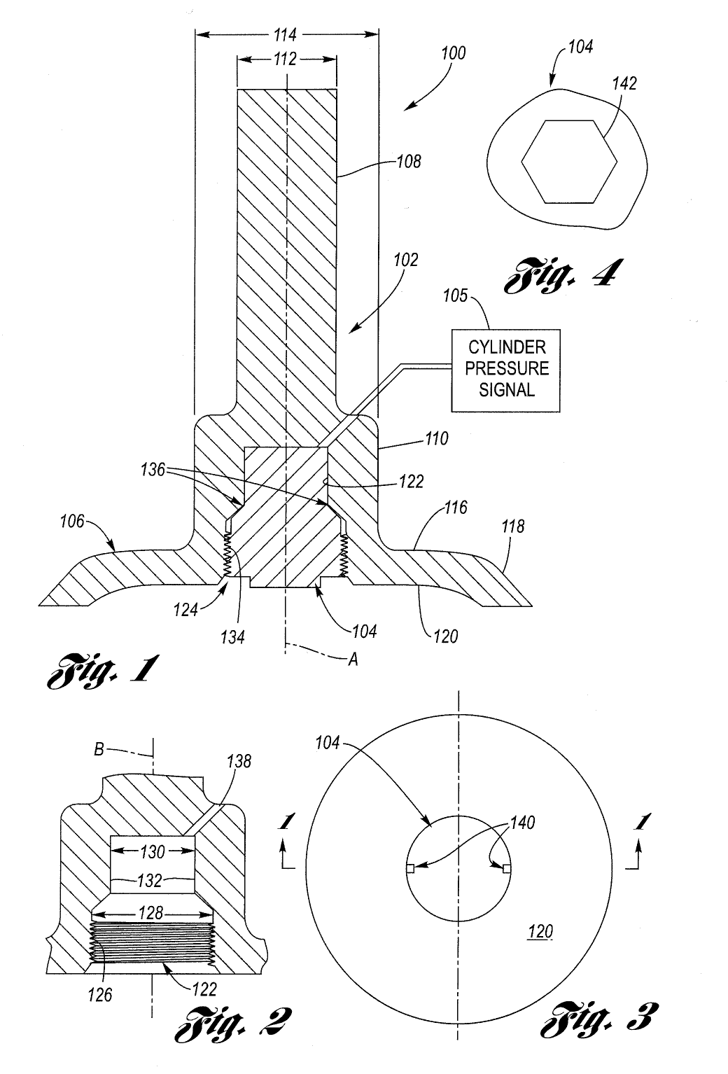

Referring now to the drawings wherein like reference numerals are used to identify identical components in the various views, FIG. 1 is a cross-sectional view of an assembled cylinder pressure sensor system 100 according to the present invention. Sensor system 100 includes an engine valve, such as an intake valve 102 and a cylinder pressure sensor 104. The present invention provides generally for the improved packaging of sensor 104 completely within valve 102 so as to allow for the normal, as-designed-for operation of the valve itself. That is, the invention does not call for materially altering the proper functioning of the valve so it will not in turn materially affect the combustion process in the cylinder. The combination valve/sensor system 100, in addition to its conventional valve function, is configured to generate a pressure signal 105 that is indicative of a sensed pressure within a combustion chamber or cylinder of the engine. The valve 102, in general terms, comprises a conventional internal combustion engine intake valve modified as described below, and may therefore generally comprise metal material.

The valve 102 includes a head portion 106, a stem portion 108 and a neck portion 110 intermediate the head and stem portions 106, 108. The stem portion 108 is generally cylindrical in shape, having a main longitudinal axis, designated “A” in the Figures, and having a predefined diameter 112. Neck portion 110 may take a variety of shapes, as known in the art; however, neck portion 110 in the illustrated embodiment is also generally cylindrical in shape, extending along the same main axis “A” as the stem portion 106, and has a predefined diameter 114 that is larger than the diameter 112. Head portion 106 is generally circular in shape and includes a first, underside 116 which features a circumferentially-extending engagement surface 118 that is configured to cooperate with (i.e., engage) a corresponding valve seat (best shown in FIG. 5) as per its intake control function, as known. The first side 116 faces the neck and stem portions. Head portion 106 also includes a second side 120 that is axially opposite side 116 and is configured to be exposed to the combustion chamber (best shown in FIG. 5) and hence will be exposed to the combustion pressures produced therein. The valve 102 further includes a blind bore 122 opening up on the second (top) side 120 of the valve head 106 and extending through the head portion 106 and into the neck portion 110. It should be appreciated that the particular geometries of head 106 will be principally determined by the needs of the engine design, while the particular geometry of the neck 110 will depend not only on the needs of the engine designer, but also on the size and shape of the pressure sensor 104.

FIG. 2 is an enlarged view of a portion of the valve 102 showing, in greater detail, the blind bore 112 and its features. The blind bore 122 is, as illustrated, generally symmetrical about a bore axis, designated “B” in FIG. 2. The bore axis “B” may be coincident with (i.e., substantially aligned with) the main axis “A”. The blind bore 122 includes a threaded section having a predefined first diameter 128 and containing first threads 126. The blind bore 122 may further include a bottom section having a second diameter 130 that is less than the first diameter 128 of the threads. Additionally, the blind bore 122 may have a sealing section 132, axially offset from and located intermediate the threaded section and the bottom section. The sealing section is radially-inwardly tapered as one moves into the blind bore 122, configured to cooperate with a corresponding tapered feature on sensor 104 to form a pressure-tight seal.

Referring back to FIG. 1, cylinder pressure sensor 104 corresponds in size and shape to match that of blind bore 122, and includes second threads 134 and a sealing surface (chamfer). That is, the size and shape of the bore is selected so that the sensor can be completely received and retained within the bore 122. In this way, the top surface of the value can function as designed and the combustion process will proceed accordingly. The outside threads 134 on the outside of sensor 104 are configured to mesh with the inside threads 126 on the inside of the bore 122 to retain the sensor 104 in the bore 122. Additionally, the relative arrangement and spacing of the cooperating threads 126, 134, on the one hand, and the sealing section 132 and the sealing surface of the sensor, on the other hand, are such that the sealing surface of the sensor will engage the sealing section 132 in the bore to form a pressure-tight seal 136. Note, this arrangement may be similar to that known for spark plugs (threads and chamfer). Cylinder pressure sensor 104 may comprise any number of conventional, well-known technologies for sensing pressure, for example, piezoelectric pressure sensors.

Returning to FIG. 2, the bore 122 also includes a through-aperture defining a guideway 138 that is configured to allow electrical conductor(s) from sensor 104 to pass therethrough for transmitting the pressure signal 105 to a processing circuit, such as an electronic controller 14 (best shown in FIG. 5). In an alternate embodiment, a wireless communication device may be employed for transmitting the pressure signal 105 from the sensor 104 to the electronic controller 14. For example, see Li Zhang, et al., “Development of a Wireless Pressure Sensor With Remote Acoustic Transmission,” 2002, NAMRC, hereby incorporated by reference in its entirety herein.

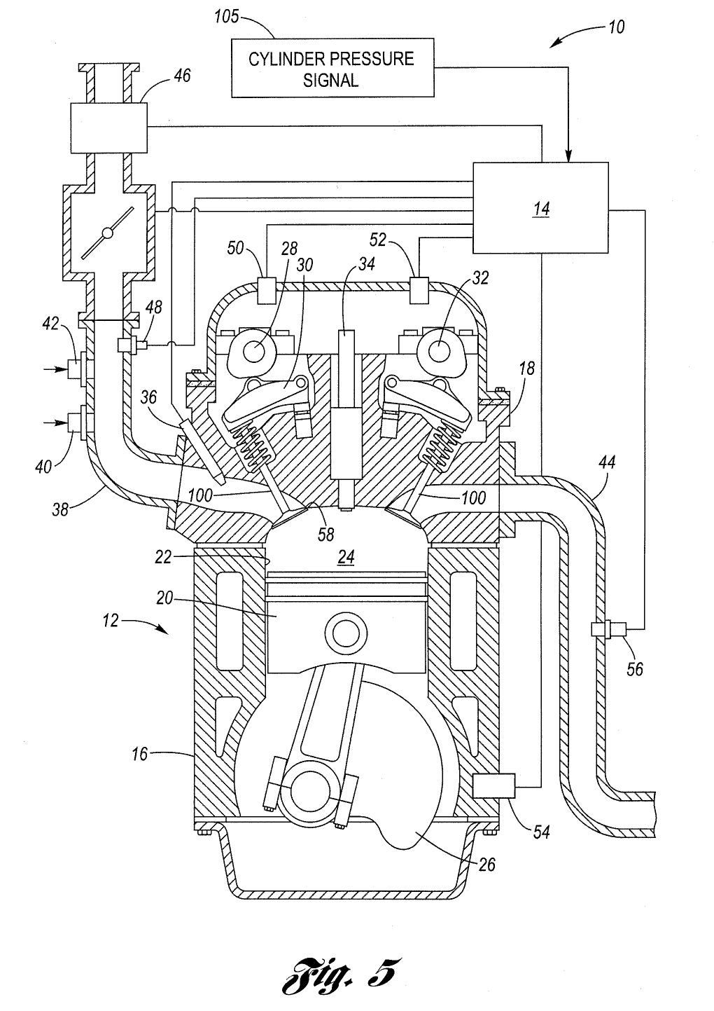

FIG. 3 is a top view of the cylinder pressure sensor system 100 shown in FIG. 1. For sensor installation and removal purposes, the sensor 104 may include an interrupted slot feature 140, although a specially-configured tool is contemplated as needed when this feature is used.

FIG. 4 is a top view of the sensor 104, showing an alternate embodiment where the sensor 104 includes a hexagonal nut 142 or the like attached (e.g., by welding) to the top of sensor 104. In this embodiment, conventional tools may be used for installation and removal of the sensor in the valve.

FIG. 5 shows a system 10 adapted to use the inventive cylinder pressure sensor system 100 of FIGS. 1-4. System 10 includes a spark-ignition internal combustion engine 12 and an electronic controller 14. The engine 12 includes a plurality of engine valves, such as an intake valve configured as a cylinder pressure sensor 100 according to the invention. In one embodiment, at least one inventive valve/sensor 100 per cylinder is deployed.

The various components of engine 10 are generally well known, and in this regard FIG. 5 shows an engine block 16, an engine head 18, a piston 20, a cylinder 22, a combustion chamber 24, a crankshaft 26, an intake camshaft 28, rocker-arm assembly 30, an exhaust camshaft 32, a spark plug 34, and a fuel injector 36. FIG. 5 also shows a supply of air being provided by an intake manifold 38 having an EGR inlet 40 and a purge valve inlet 42. FIG. 5 also shows an exhaust manifold 44. Various well known sensors are also shown including a mass air flow (MAF) sensor 46, an intake manifold pressure sensor 48, a pair of camshaft position sensors 50, 52, a crankshaft sensor 54, and an exhaust gas oxygen sensor 56. FIG. 5 also shows a valve seat 58, which is configured to be engaged by surface 118 of the valve head 106, as known. In general, the engine system 10 functions as known in the art. However, system 10 has been adapted to use intake valve/sensor system 100 for producing the cylinder pressure signal 105. With this information, controller 14 can be configured to perform, or perform with improved function, a variety of control functions known in the art, including but not limited to calculation and adjustment of fuel delivery and spark timing parameters.

The controller 14 comprises an electronic controller signally connected to the plurality of engine sensors, operably connected to the plurality of output devices, and containing various pre-established software algorithms and predetermined calibrations. The controller 14 includes at least one microprocessor, associated memory devices, input devices for collecting and monitoring input from external analog and digital devices, and output drivers for controlling output devices. The controller 14 is operable to monitor engine operating conditions and operator inputs using the plurality of sensors, and control engine operations with the plurality of output systems and actuators, using the pre-established algorithms and calibrations that integrate information from monitored conditions and inputs.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

1. A cylinder pressure sensor system for an internal combustion engine, comprising:
a valve having a head and a stem that extends from said head, said head being configured to cooperate with a valve seat of a combustion chamber of said engine; and
a pressure sensor received within said valve configured to generate a pressure signal indicative of a pressure in said combustion chamber.

2. The sensor of claim 1 wherein said valve stem extends along a main axis, said head having a first side configured to cooperate with the valve seat, said head further including a second side axially opposite said first side, said second side configured to be exposed to pressure in the cylinder of the engine, said sensor being disposed on said second side.

3. The sensor of claim 2 wherein said valve further includes a neck portion intermediate said head and said stem, said valve having a blind bore extending though said head into said neck portion, said blind bore opening on said second side of said head.

4. The sensor of claim 3 wherein said blind bore is a bore axis that is substantially aligned with said main axis.

5. The sensor of claim 3 wherein said blind bore includes first threads, said pressure sensor including second threads configured to mesh with said first threads so as to completely receive within and retain said sensor in said blind bore.

6. The sensor of claim 5 wherein said first threads are formed in said blind bore on a first section having a first diameter, said blind bore having a second section axially offset from said first section with a second diameter less than said first diameter, said blind bore having a tapered sealing section intermediate said first and second sections, said pressure sensor having a seal surface corresponding to said sealing section and configured to engage said sealing section when said first and second threads are in mesh so as to form a seal.

7. The sensor of claim 6 wherein said neck portion includes a guideway configured for electrical connections to pass therethrough coupling said pressure signal to a processing circuit.

8. The sensor of claim 7 wherein said processing circuit comprises an electronic engine controller.

9. The sensor of claim 6 further including a wireless communication device proximate said pressure sensor for enabling wireless transmission of said pressure signal to a processing circuit

10. The sensor of claim 1 wherein said valve is an intake valve.

11. The sensor of claim 1 wherein said valve comprises metal material.

12. A cylinder pressure sensor system for determining a pressure in a cylinder of an internal combustion engine, comprising:
a valve having a circular head portion, a cylindrical stem portion and a neck portion intermediate said head and stein portions, said stem portion extending along a main axis and having a first diameter, said neck portion being cylindrical, extending along said main axis and having a second diameter larger than said first diameter, said head portion having a first side facing said neck and stem portions and including a circumferentially extending seal configured to cooperate with a corresponding valve seat in an engine, said head portion having a second side axially opposite said first side configured to be exposed to pressure in the cylinder of the engine, said head portion including a blind bore opening on said second side, said blind bore having a first section having first threads and a tapered sealing section; and
a pressure sensor having a cylindrical body with second threads on an exterior thereof configured to mesh with said first threads of said blind bore so that said sensor is received and retained within said valve body, said body further including a seal surface configured to engage said sealing section to form a seal.
